(19) United States
(12) Patent Application Publication
(10) Pub. No.: US 2009/0027464 A1
(43) Pub. Date: Jan. 29, 2009

(54) WIDE FORMAT INK CARTRIDGE

(76) Inventor: Richard H. Berg, Hilton, NY (US)

Correspondence Address: FAY SHARPE LLP, 1100 SUPERIOR AVENUE, SEVENTH FLOOR, CLEVELAND, OH, 44114, US

(21) Appl. No.: 12/179,045

(22) Filed: Jul. 24, 2008

Related U.S. Application Data
(60) Provisional application No. 60/961,779, filed on Jul. 24, 2007.

(51) Int. Cl. B41J 2/175

(52) U.S. Cl. 347/86

(57) ABSTRACT

An ink cartridge has a body having a plurality of side walls forming an internal cavity therein. An ink supply flow path is formed in one of the side walls. An ink supply port is formed in another of the side walls. The port is fluidically connected to the ink supply flow path. A memory device for storing information for the ink. A housing is provided for the memory device. The housing has first and second walls extending from a surface into which said memory device is installed for aligning the memory device and maintaining electrical contact between the memory device and an electrical contact assembly of a printer.

### CLAIM OF PRIORITY

This patent application claims priority from U.S. Provisional Patent Application No. 60/961,779 filed on Jul. 24, 2007, the contents of which are incorporated herein by reference.

### BACKGROUND OF THE INVENTION

The present invention relates to an ink cartridge and an ink cartridge holder. More particularly, the present invention relates to the ink cartridge for supplying ink to a recording apparatus.

Generally, an ink jet recording apparatus is designed to print data by causing the recording head to move back and forth along the width of a recording sheet. Ink is supplied from an ink supply source to the recording head. As a result, the ink jet recording apparatus that must produce a large number of copies must carry a larger-sized ink cartridge which cannot be mounted on a carriage. Thus, the ink cartridge is mounted on the housing of the recording apparatus, and the ink may be supplied to the recording head through a tube.

In accordance with one aspect of the invention, ink jet recording apparatus can be provided which includes an ink cartridge holder on which an ink cartridge filled with ink is detachably mounted. A large-size ink cartridge is used for the ink jet recording apparatus which records on large-size papers, such as posters or the like, in order to cope with a large quantity of ink consumption.

The ink cartridge used for the ink jet recording apparatus may be provided with a memory device or chip which stores information, such as a type of ink, color of ink, remaining amount of ink and the like. An information reading section is provided on the ink cartridge holder at a position facing the chip when the ink cartridge is mounted on the ink cartridge holder, and the chip on the ink cartridge and the information reading section on the ink cartridge holder are electrically connected and communicate with each other.

Existing wide format ink cartridges often have a bag or collapsible ink reservoir contained within a rigid housing. An example of such a cartridge is shown in U.S. Pat. No. 6,053,606. A problem with this arrangement is that as the bag collapses, pockets of ink become trapped in the bag, thus reducing the efficiency of the cartridge. Also, air bubbles may form in the ink supply port, and become trapped as well, which may result in imaging defects at the printer. The printer is designed to allow the customer to remove the cartridge to swap out different colors within the same port. Every time the cartridge is re-inserted into the printer, air is injected into the cartridge and positioned within the same compartment where the ink needle will be. This will provide the opportunity for air to be suctioned into the printer's ink line and create imaging defects such as missing jets or the entire color to deprime. Each cartridge insert adds significantly more air into the cartridge, thus, drastically accelerating printing failure. As the ink is consumed from printing, it can be expected that the customer will swap different colors based on the design of the printer. If the cartridge is laid on its side where the ink inlet is at the elevated position, air will enter into the ink fluid channel due to density of the two fluids. Upon re-inserting this cartridge back into the printer's port, the air due to buoyancy will float into the horizontal chambers where the printer's ink needle is located.

Trapped air bubbles in the ink fluid path are suctioned into the printer's ink. This trapped air results in missing jets or depriming of the entire color in the printing images.

There are at least four ways for bubbles to be formed in compartments of the ink fluid flow path of the cartridge. A first way is during ink filling of the cartridge, which may leave initial air bubbles in the fluid path section. If the cartridge is vacuum filled, air will be left behind in the cartridge after filling the cartridge. The air enters into the ink fluid flow path of the cartridge by orientating the air bubbles at the inlet. A second way that air bubbles are formed is during packaging and shipment of the cartridge. A third way is if the cartridge is laid flat on the table, air bubbles will wick into the fluid passage and float forward and possibly deprime the cartridge.

Fourth, as the cartridge is inserted into the printer, the design of the septum or valve in the ink supply port will trap free air as the ink travels from the cartridge to the printer. The rubber septum has a cylindrical cavity but seals to the outer diameter of the printer's ink needle by a compression fit. The nose of the printer's ink needle is typically a tapered cylinder which traps the air in the cylindrical volume of the rubber septum. This trapped air is squeezed into the ink cartridge's fluid compartment(s).

Existing cartridges may have issues with maintaining alignment of a memory device or chip on the cartridge and an electrical contact on the printer, and maintaining electrical contact.

Thus, it is desirable to provide an ink cartridge which overcomes the above-mentioned deficiencies and others while providing better and overall more advantageous results.

### SUMMARY OF THE INVENTION

The present invention relates to an ink cartridge. More particularly, it relates to a wide format ink cartridge for use with an ink cartridge holder.

In accordance with one aspect of the invention, an ink cartridge has a body having a plurality of side walls forming an internal cavity therein; an ink supply flow path formed in one of the side walls; an ink supply port formed in another of the side walls, the port is fluidically connected to the ink supply flow path; a memory device is provided for storing information for the ink; and a housing for the memory device is provided, the housing has first and second walls extending from a surface into which said memory device is installed.

Another aspect of the present invention is the provision of an ink cartridge which holds ink in an internal cavity without the use of a bag.

Another aspect of the invention is the provision of a housing on the cartridge for surrounding an electrical contact on the printer for improving electrical contact.

Yet another aspect of the invention is the provision of guide rails on the housing for improving alignment of the cartridge with an electrical contact on the printer.

Other aspects of the invention will become apparent upon a reading and understanding of the following detail description.

### BRIEF DESCRIPTION OF THE DRAWINGS

The foregoing advantages of the present invention, and others, will in part be obvious and in part pointed out more fully hereinafter in conjunction with the written description of the embodiments illustrated in the accompanying drawings in which:

FIG. 1 is a perspective view of a front side of an ink cartridge in accordance with a first embodiment of the present invention;

FIG. 2 is a partial elevational view of a side wall of the ink cartridge of FIG. 1;

FIG. 3 is a front elevational view of a front wall of the cartridge of FIG. 1;

FIG. 4 is a perspective view of the rear side of the cartridge of FIG. 1;

FIG. 5 is a perspective view of an ink cartridge holder which receives the ink cartridge of FIG. 1;

FIG. 6 is a top plan view of an ink cartridge being inserted into the ink cartridge holder of FIG. 5;

FIG. 7 is a top plan view of the ink cartridge of FIG. 1 with the cover removed;

FIG. 8 is a perspective view of the ink cartridge of FIG. 1 showing the cover installed;

FIG. 9 is a perspective view of an ink cartridge having a housing for a memory device in accordance with a preferred embodiment of the present invention;

FIG. 10 is a partial enlarged view of the housing for a memory device of the cartridge of FIG. 9 in accordance with a preferred embodiment of the present invention;

FIG. 11 is an enlarged perspective view of another embodiment of a memory device housing in accordance with the present invention;

FIG. 12 is an enlarged view of an electrical contact assembly of a printer; and

FIG. 13 is a plan view of a memory device housing of FIG. 10 surrounding the electrical contact assembly of the printer of FIG. 12.

### DETAILED DESCRIPTION OF THE INVENTION

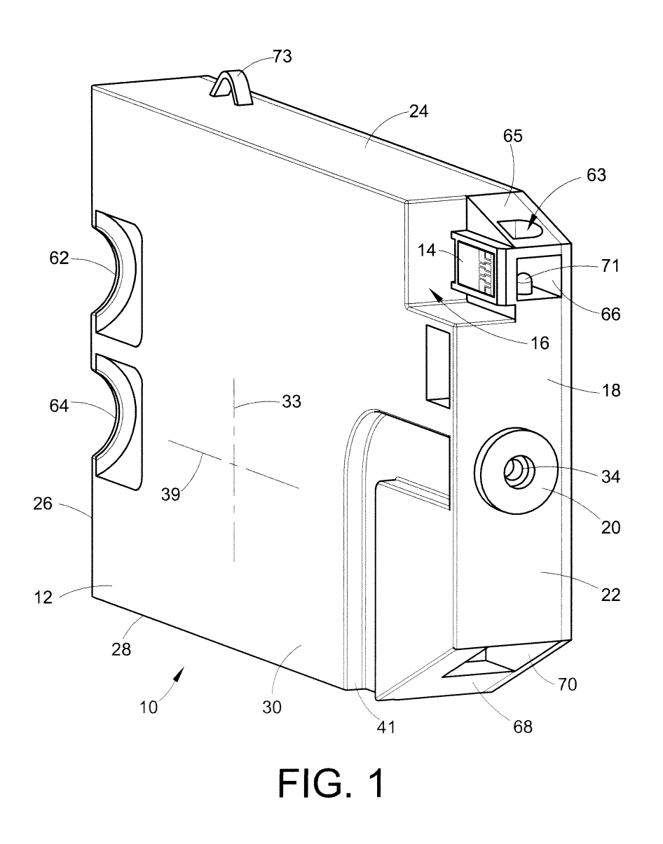

Referring now in greater detail to the drawings, wherein the showings are for the purpose of illustrating preferred embodiments of the invention only and not for the purpose of limiting the invention, FIG. 1 is a front perspective view of the ink cartridge according to the first embodiment of the present invention An ink cartridge 10 according to the first embodiment includes an ink cartridge main body 12 having a substantially rectangular parallel piped shape, an information storing unit 14 provided on a recess 16 which is adjacent a first side or a first wall 18 of the ink cartridge main body, and an ink supply unit 20 provided on a front surface 22 of wall 18. The body is formed by side walls 18, 24, 26, 28 and wall 30.

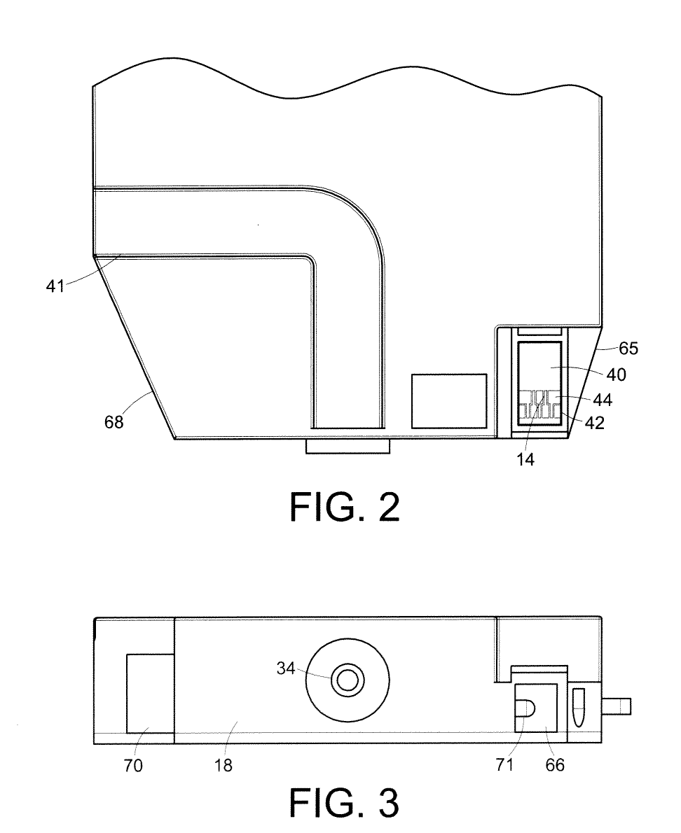

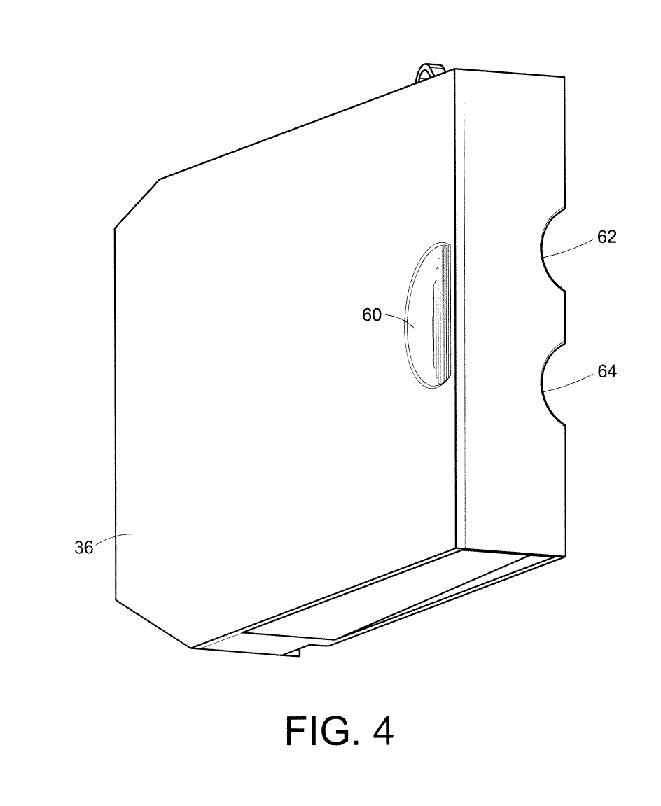

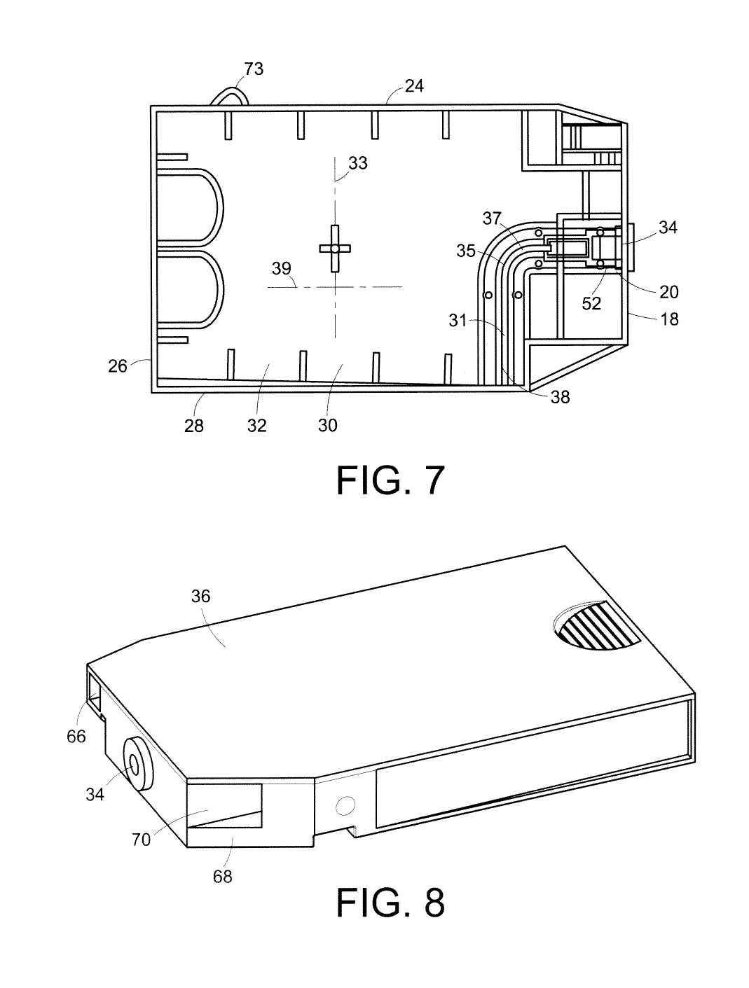

The ink cartridge main body includes a cavity 32 with one side being open, an ink supply port 34 (FIG. 3) provided at end 18 and is fixed to end 18, and a substantially flat cover plate 36 (FIG. 4). In this ink cartridge main body, the internal cavity 32 of the cartridge is substantially filled up with ink. The internal cavity 32 is formed by walls 18, 24, 26, 28, and 30 of the main body. An ink supply flow path 38 (FIG. 7) such as a channel for facilitating flow of ink from the main body to the ink supply port is provided in a recess 41 (FIG. 2) of wall 30. The channel 38 has a first, straight portion 31 extending along a first axis 33 of the body and a curved portion 35 connecting a second straight portion 37 extending perpendicular to first portion 31 and along second axis 39 of the body. The cover is fixed to the side walls 18, 24, 26, 28 of the container main body, such as by vibration, welding, or the like, with the internal cavity 32 of the container being enclosed by the cover. Thereby, a large quantity of ink is held and the large quantity of the ink is supplied to the ink jet recording apparatus stably which records on large-size papers such as posters or the like.

The information or memory storing unit 14 of the ink cartridge stores information, such as a type of ink and the ink cartridge, color of the ink in the ink cartridge, and remaining amount of the ink. For example, as shown in FIG. 2, the information storing unit is a contact type chip. The contact type chip includes a substrate 40, a connection electrode section 42 including a plurality of connection terminals 44 which are exposed to the front surface of the substrate, and memory including a semiconductor memory element, such as EEPROM provided on a back side of the substrate. The information data in the memory is read or rewritten through the connection terminals 44 electrically connecting with connection electrodes of the recording apparatus. In the present embodiment, the information storing or memory unit is of a contact type which is provided with the connection electrode section 42 including the plurality of connection terminals 44 exposed outside.

Seven connection terminals are typically arranged adjacent each other in the present embodiment as shown in FIG. 2. Alternatively, for example, the memory of the information storing unit may be provided on the other wall of the cartridge main body or the like and connects with the connection electrode section, which is provided on the first wall, via a flexible print circuit (FPC).

The recess 16 may be provided adjacent the first wall 18 of the ink cartridge main body as shown in FIG. 2. The information storing or memory unit and the connection electrode section are arranged in the recess. Moreover, since the upper part of the connection terminal surface is opened to the outside in the recess, the information storing unit is easily mounted on the ink cartridge main body during manufacturing of the ink cartridge.

The ink supply port 34 is provided in the ink supply section of the ink cartridge, and the ink is supplied to the recording apparatus main body from the ink cartridge through the ink supply port. An ink supply needle 50 (FIG. 6) of the recording apparatus is inserted in the ink supply port. A valve or septum 52 (FIG. 7), which can be perforated or have a slit, is penetrated by insertion of the ink supply needle, and is provided within the ink supply port.

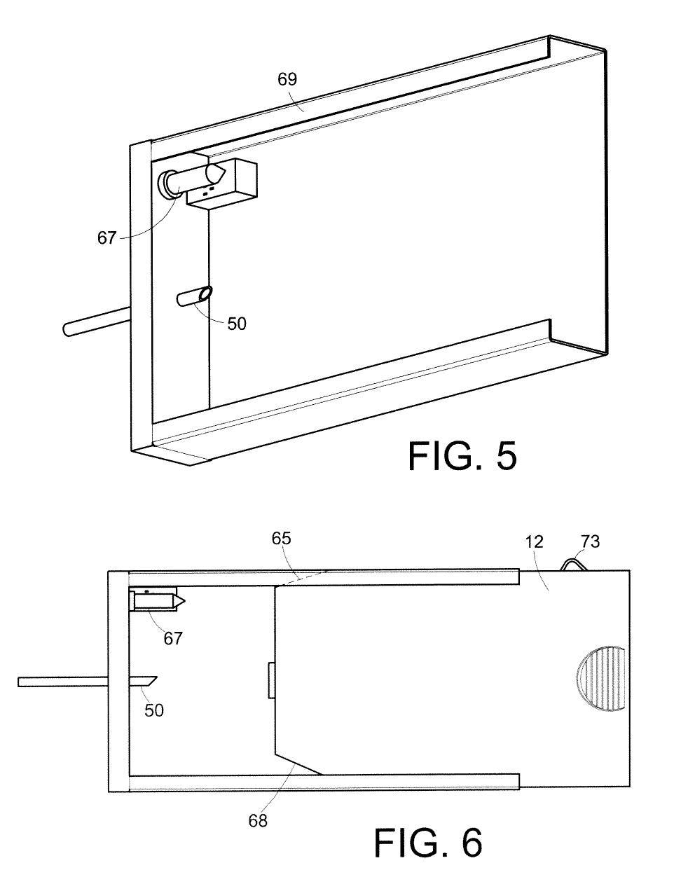

Referring to FIG. 4, in the rear side of the ink cartridge, there includes a gripping portion 60 and two finger indentations or recesses 62, 64 for enabling a user to securely grip the ink cartridge, and to easily attach/detach the ink cartridge to/from the ink cartridge holder of the ink jet recording apparatus. Referring to FIGS. 1, 3 and 8, at a front end of the cartridge, the cartridge further has a substantially square-shaped opening 66 positioned adjacent the memory unit into which a positioning rod 67 (FIG. 5) of the ink cartridge holder 69 may extend. A spring biased pin 71 may be depressed and keep a positioning rod aligned within opening 66. An angled or sloped surface 65 is formed adjacent opening 66 and the memory device 14. On the other side of the cartridge, an angled surface 68 is formed in which a slotted opening 70 is formed. A second positioning member (not shown) of the ink cartridge holder may extend into the slotted opening. A projecting member 73 (FIGS. 1, 7) extending from side wall 24 helps guide and align the cartridge into its holder. The projecting member may be flexible or biased. The angled surfaces 65 and 68 at an upper corner and a lower corner help align, locate and center the cartridge and guide it into the holder as it is inserted as seen in FIG. 6. The upper angled wall also serves as a shield for the cartridge venting mechanism (pin 71 which is spring biased) which may allow ink to escape if depressed prior to insertion into the printer. A recess 63 is also provided for the venting mechanism to catch any ink that may leak from around the vent seal during insertion.

Referring to FIG. 6, the front surface of the cartridge is inserted into the holder main body of the ink cartridge holder. Positioning members of the holder oppose opening 66 and slotted opening 70. The ink supply needle 50 of the holder is positioned opposite the ink supply port 34 of the ink cartridge. The ink cartridge is slid into the holder cavity until the connection electrodes of the information reading section of the holder controls connection terminals of the connection electrode section of the information sharing unit in the ink cartridge.

Existing cartridges have difficulty with maintaining alignment of the memory device with an electrical content assembly on a printer, and maintaining electrical contact between the memory device and the electrical content assembly on the printer once the cartridge is installed on the printer.

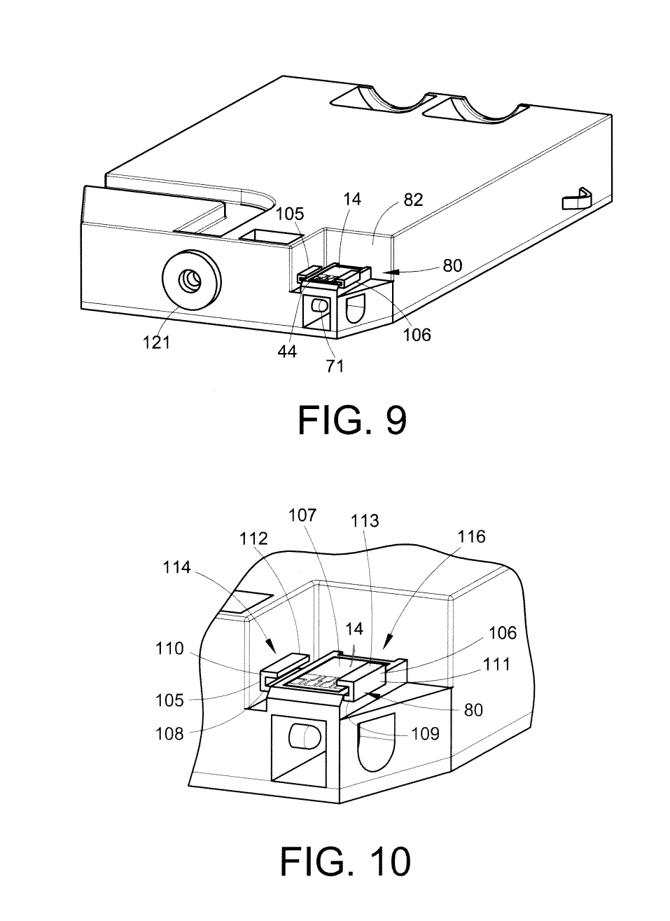

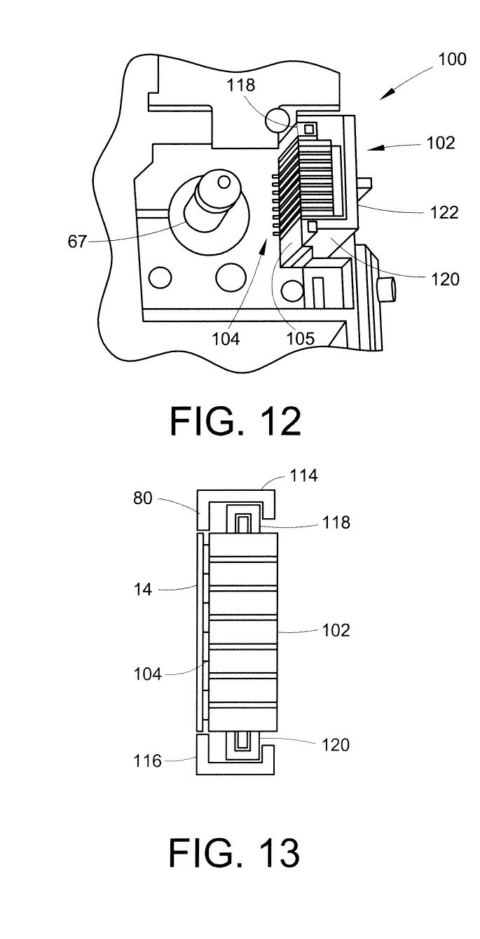

In accordance with a preferred embodiment of the present invention, FIGS. 9 and 10 illustrate the ink cartridge of FIGS. 1-8 further having a housing for memory device or chip 14. The cartridge has a housing assembly 80 which improves the accuracy of making electrical contacts with a printer electrical contact with a printer electrical contact assembly 100 (FIG. 12). The housing is positioned within recess 82 of the cartridge. The housing 80 is configured to at least partially or even substantially surround a top and bottom surface of a printer pin subassembly 102 that locates the printer contact assembly. Pins 104 on wall 105 of the contact assembly contact the memory device connection terminals 44.

The housing includes two walls 105, 106 which are formed on opposite sides of and extend from a surface 107 onto which the memory device 14 is secured. Walls 105 and 106 are substantially parallel to each other and are substantially perpendicular to surface 107. The walls may further wall portions 108, 109 which extend parallel to and from surface 107. The walls have first portions 110, 111 and second portions 112, 113 which extend from first portions 110, 111. First portions 110 and 111 are substantially parallel to each other and are substantially perpendicular to second portions 112, 113. Second portions 112, 113 are also substantially parallel to each other.

Referring to FIG. 13, the housing walls form guide rails 114, 116 that are able to slide over top and bottom surfaces 118, 120 of the connector assembly. The guide rails locate the memory device or chip 14 in a more precise alignment with the electrical contact pins 104 on the printer. The rails reduce variations in the tolerance stack up on the cartridge including the vent spring and pin 71 tolerances, the sealing membrane 121 tolerances, angular misalignment with the cartridge, and stiffness variation in the guide pin 67 that activates the vent spring.

The rails 114, 116 may contact and slide on a block 122 on which the electrical contact assembly of the printer is installed to maintain planar alignment with the electrical contact assembly pins 104 and the electrical connectors 44 on the memory device.

The rails may contact a wall of the connector block and may encounter some pressure during installation but will assist in maintaining alignment and electrical contact between the memory device 14 and the electrical contact assembly 100 of the printer.

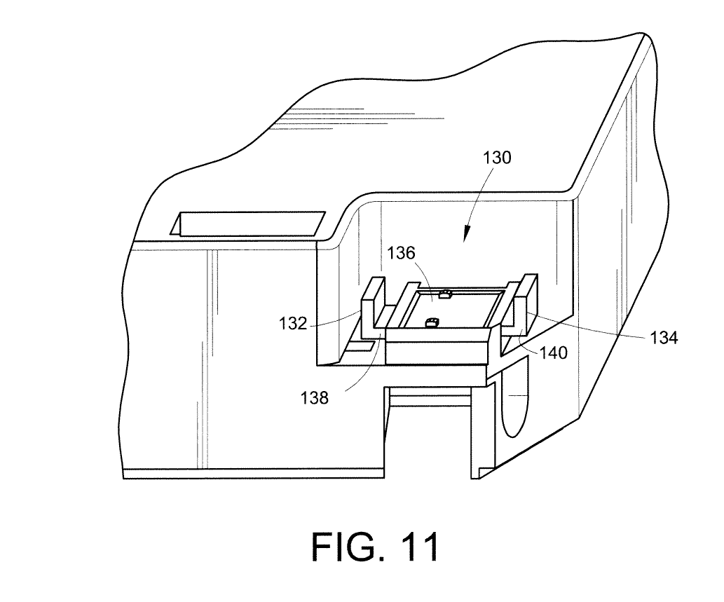

Referring to FIG. 11, an alternate embodiment of the memory device housing 130 is shown. The housing has first and second walls 132, 134 which are substantially parallel to each other and extend from a surface 136 on which a memory device or chip 14 is mounted. Walls 132 and 134 may also have portions 138, 140 which extend from and are substantially parallel to surface 136. When the cartridge is slid into the printer, walls 132, 134 maintain planar alignment between the memory device and the electrical contact assembly 100 of the printer. The walls 132 and 134 slide over and at least partially surround top and bottom surfaces 118, 120 of the printer electrical contact assembly similar to the embodiment of FIGS. 9, 10 and 13.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An ink cartridge comprising:
a body having a plurality of side walls forming an internal cavity therein;
an ink supply flow path formed in one of said side walls;
an ink supply port formed in another of said side walls, said port is fluidically connected to said ink supply flow path;
a memory device for storing information for the ink;
and a housing for said memory device, said housing comprising first and second walls extending from a surface into which said memory device is installed, said housing positioned adjacent one of said side walls.

2. The ink cartridge of claim 1, wherein said first and second walls of said housing are substantially parallel to each other.

3. The ink cartridge of claim 1, wherein said first and second walls of said housing are substantially perpendicular to said surface onto which said memory device is installed.

4. The ink cartridge of claim 1, wherein said housing for said memory device is positioned within a recess of said cartridge body.

5. The ink cartridge of claim 1, wherein said internal cavity is substantially filled with ink.

6. The ink cartridge of claim 1, wherein said first and second walls of said housing each comprise a first portion and a second portion, wherein said first and second portions are substantially perpendicular to each other.

7. The ink cartridge of claim 6, wherein said first portion of said first wall and said first portion of said second wall are substantially parallel to each other.

8. The ink cartridge of claim 6, wherein said second portion of said first wall of said housing and said second portion of said second wall of said housing are substantially parallel to each other.

9. The ink cartridge of claim 1, wherein said first and second walls of said housing at least partially surround an associated electrical contact assembly on an associated printer when said cartridge is installed in said printer.

10. The ink cartridge of claim 6, wherein said first and second portions of each of said first and second walls of said housing at least partially surround an associated electrical contact assembly on an associated printer when said cartridge is installed on said printer.

11. The ink cartridge of claim 1, wherein said memory device maintains electrical contact with an associated electrical contact assembly on an associated printer when said memory device housing is slid into place adjacent said electrical contact assembly.

12. The ink cartridge of claim 6, wherein said memory device maintains electrical contact with an associated electrical contact assembly on an associated printer when said memory device housing is slid into place adjacent said electrical contact assembly.

13. The ink cartridge of claim 1, wherein said memory device maintains alignment with an associated electrical contact assembly on an associated printer when said memory device housing is slid into place adjacent said electrical contact assembly.

14. The ink cartridge of claim 6, wherein said memory device maintains alignment with an associated electrical contact assembly on an associated printer when said memory device housing is slid into place adjacent said electrical contact assembly.
